(19) United States
(12) Patent Application Publication
(10) Pub. No.: US 2009/0248506 A1
(43) Pub. Date: Oct. 1, 2009

(54) MERCHANT FUNDED REWARDS NETWORK IMPLEMENTING CARDHOLDER LOYALTY REBATE PROGRAM

(75) Inventors: Alan Goldstein, Marietta, GA (US); Timothy Crank, St. Louis, MO (US); Julia Bailey, St. Louis, MO (US)

Correspondence Address: SENNIGER POWERS LLP, 100 NORTH BROADWAY, 17TH FLOOR, ST LOUIS, MO, 63102, US

(73) Assignee: MARITZ INC., Fenton, MO (US)

(21) Appl. No.: 12/058,945

(22) Filed: Mar. 31, 2008

(51) Int. Cl. G06Q 30/00; G06Q 20/00

(52) U.S. Cl. 705/14

(57) ABSTRACT

A system and method for implementing a program such as a loyalty program. An account (e.g., card) system includes a plurality of participating account holders (e.g., cardholders) of an issuer, a plurality of non-participating account holders (e.g., cardholders) of the issuer and of other issuers, a plurality of non-preferred merchants of the issuer and of other issuers and a plurality of preferred merchants of the issuer. A filter is used to evaluate transactions to identify qualifying program transactions involving both a participating account holders (e.g., cardholders) of the issuer and a preferred merchant of the issuer. Rebates are provided for identified, qualifying program transactions.

### TECHNICAL FIELD

Embodiments of the present invention relate to the programs which establish a network to increase purchases from program merchants using credit, debit and other cards such as membership cards. In particular, embodiments of this invention relate to loyalty or rebate programs which provide rebates to encourage account holders, such as cardholders, who are part of the program, such as a loyalty program, to use their accounts (e.g., cards) frequently to buy products and/or services from preferred merchants who are part of the program.

### BACKGROUND OF THE INVENTION

Some prior credit and debit card systems provide rebates for cardholders. However, these systems frequently process the rebates via the acquirer or directly via the merchant. This usually requires that many relationships have to be negotiated and many files have to be received from various acquirers or many merchants. Also, such systems are not configured in such a way that nonparticipating cardholders who are not receiving rebates can easily be made aware that they may qualify for rebates. In addition, some systems are administered by paper transactions which may limit access to information about the rebates.

Accordingly, a system is desired to address one or more of these and other disadvantages.

### SUMMARY OF THE INVENTION

A system and method for implementing a program such as a loyalty program. An account (e.g., card) system includes a plurality of participating account holders (e.g., cardholders) of an issuer, a plurality of non-participating account holders (e.g., cardholders) of the issuer and of other issuers, a plurality of non-preferred merchants of the issuer and of other issuers and a plurality of preferred merchants of the issuer. A filter is used to evaluate transactions to identify qualifying program transactions involving both a participating account holders (e.g., cardholders) of the issuer and a preferred merchant of the issuer. Rebates are provided for identified, qualifying program transactions.

Alternatively, the invention may comprise various other methods, systems and apparatuses.

Other features will be in part apparent and in part pointed out hereinafter.

### BRIEF DESCRIPTION OF THE DRAWINGS

FIG. 1 is a block diagram of one embodiment of the system of the invention.

FIGS. 2A and 2B are an exemplary flow chart illustrating one embodiment of the operation of the invention wherein the loyalty program is operated separately from the payment system. The preferred merchant receives via an acquirer the purchase price. The payment system charges the participating cardholder the purchase price. The loyalty program separately collects a rebate from the preferred merchant and pays X % of the rebate to the participating cardholder.

FIGS. 3A and 3B are an exemplary flow chart illustrating one embodiment of the operation of invention wherein the loyalty program is operated integrally with the payment system. The payment system charges the participating cardholder the purchase price less X % of a rebate. The preferred merchant receives via an acquirer the purchase price less administrative fees and less the rebate.

FIGS. 4A and 4B are flow charts in which FIG. 4A illustrates an exemplary embodiment of the daily incoming and outgoing transaction file process according to the invention and in which FIG. 4B illustrates an exemplary embodiment according to the invention of the process of notifying non-participating cardholders of the potential for rebates by posting non-monetary rebates to non-participating cardholders for the purpose of enticing the non-participating cardholders to enroll in the program and become participating cardholders.

FIG. 5 is a flow chart illustrating an exemplary embodiment of the settlement process for a transaction involving a preferred merchant and a participating cardholder according to the invention.

FIG. 6 is a block diagram of one embodiment of the merchant rewards network of the invention.

Corresponding reference characters indicate corresponding parts throughout the drawings.

### DETAILED DESCRIPTION OF THE INVENTION

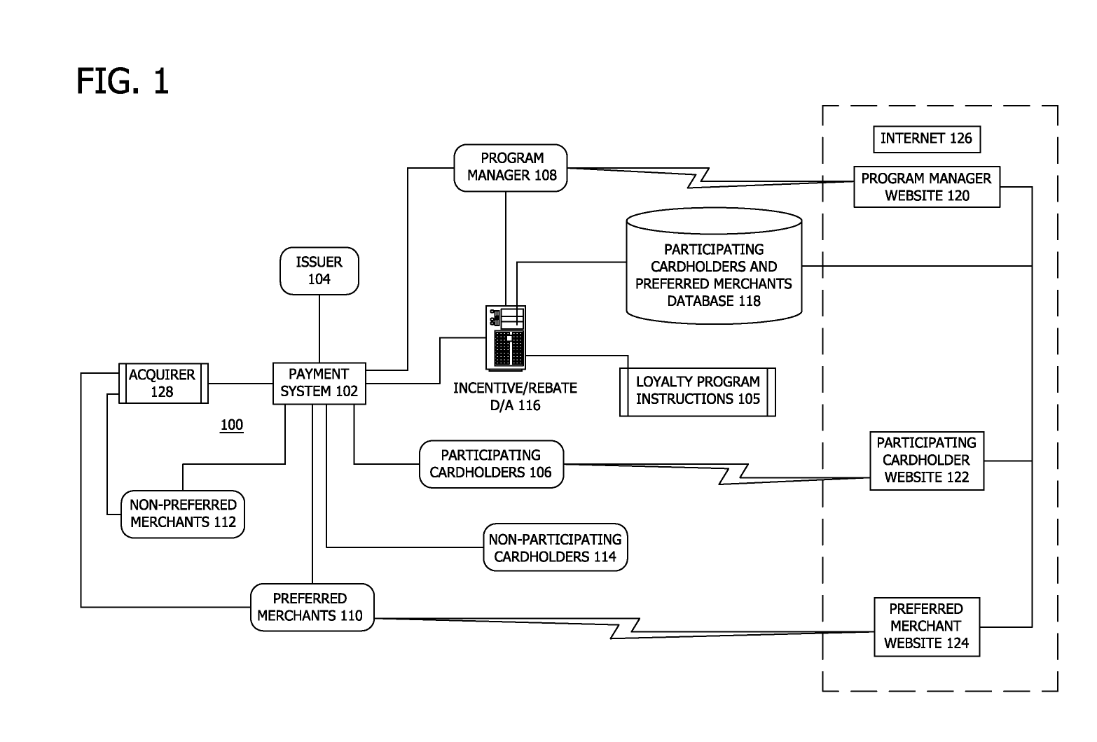

One embodiment of hardware, software and related aspects of a system 100 according to the invention is illustrated in block diagram form in FIG. 1. A payment system such as a card system 102 (including but not limited to a debit and/or credit card system operated by an issuer such as a bank or other issuer 104) implements software including instructions for a program such as loyalty program 105 for a plurality of account holders such as cardholders 106 (e.g., consumers) participating in the program and authorized to transact business via the card system 102. As used herein and in the claims, card system shall include but not be limited to any payment system such as card systems employing credit cards, debit cards, smart cards, private label payment cards, and/or pre-paid cards. As used herein and in the claims, account shall include but not be limited to any credit card, debit card, smart card, private label payment card, and/or pre-paid card. The loyalty program 105 is managed by an administrator (which may or may not be a card issuer), herein a program manager 108, operating software executed by an rebate database application (D/A) 116 which may be executed by a server or executed by some other processor, as noted below, which accesses a database 118 of participating cardholders 106 and preferred merchants 110.

As used herein, loyalty program 105 includes but is not limited to any program, loyalty plan or policy used to encourage or reward a participant's use of particular, preferred merchants which sell goods and/or services and/or encourage account (e.g., card) usage. Frequently, such programs are referred to as rebate, incentive, frequency, affinity, retention, or performance improvement programs. This is because such programs encourage or improve participant loyalty, affinity, retention, quality of performance or frequency of performance. The program permits the participants to obtain a rebate such as a motivational award (such as points, cash, products and/or services). As used herein, incentives and rebates are used interchangeably and generally denote but are not limited to any type of consideration being administered by a program.

In general, the system and method presented below is described as a card system implementing a loyalty program, which is one embodiment of the invention. However, the invention includes any payment or account system implementing any program.

As part of the loyalty program 105, the plurality of preferred merchants 110 who are authorized to transact business via the card system 102 have a contractual and/or business relationship with regard to the loyalty program and have agreed to participate in the loyalty program and the handling of transactions and rebates as described in more detail below. The card system 100 also includes a plurality of non-preferred merchants 112 who are not participating in the loyalty program 105 but accept cards of the card system 102 and are authorized to transact business via the card system 102. The card system 102 also includes a plurality of non-participating cardholders 114 who are not participating in the loyalty program 105 but accept cards of the card system 102 and are authorized to transact business via the card system 102.

As noted below, the database application 116 executes software implementing the loyalty program 105 and interfaces with an optional program manager website 120, a participating cardholder website 122 and a preferred merchant website 124 via the Internet 126.

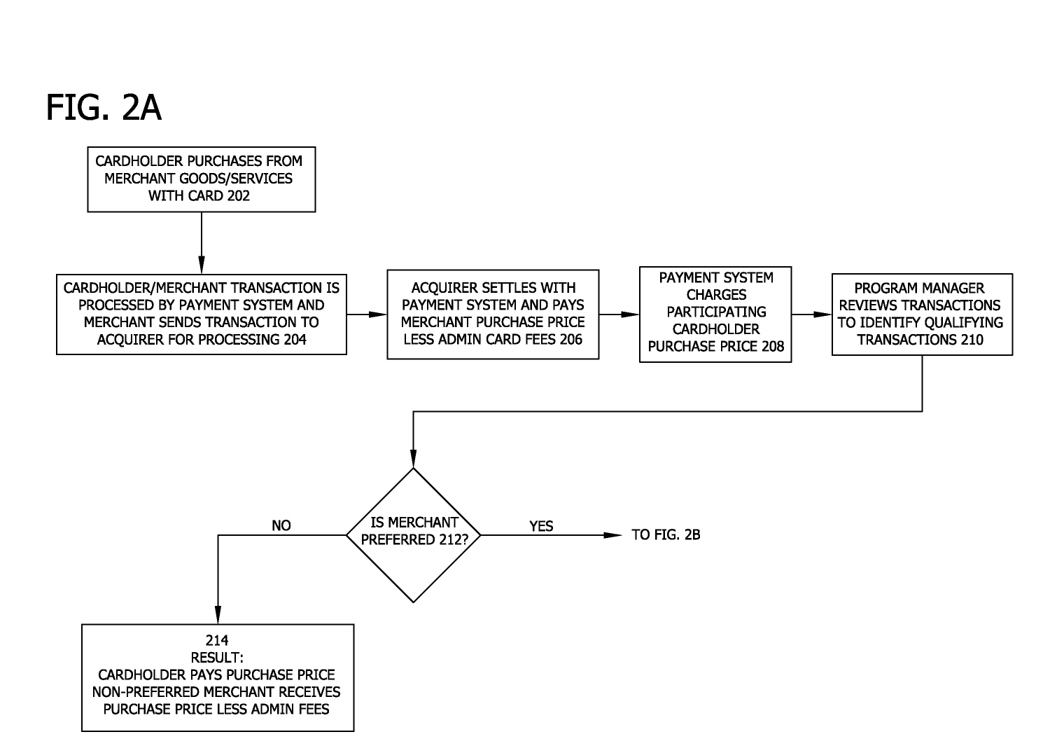

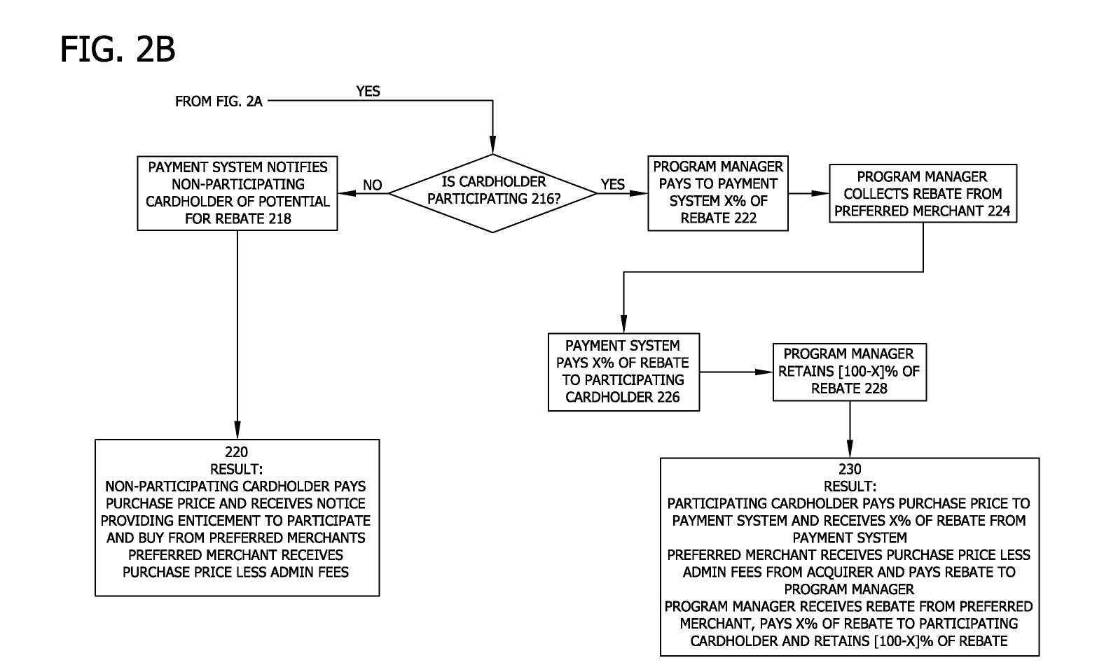

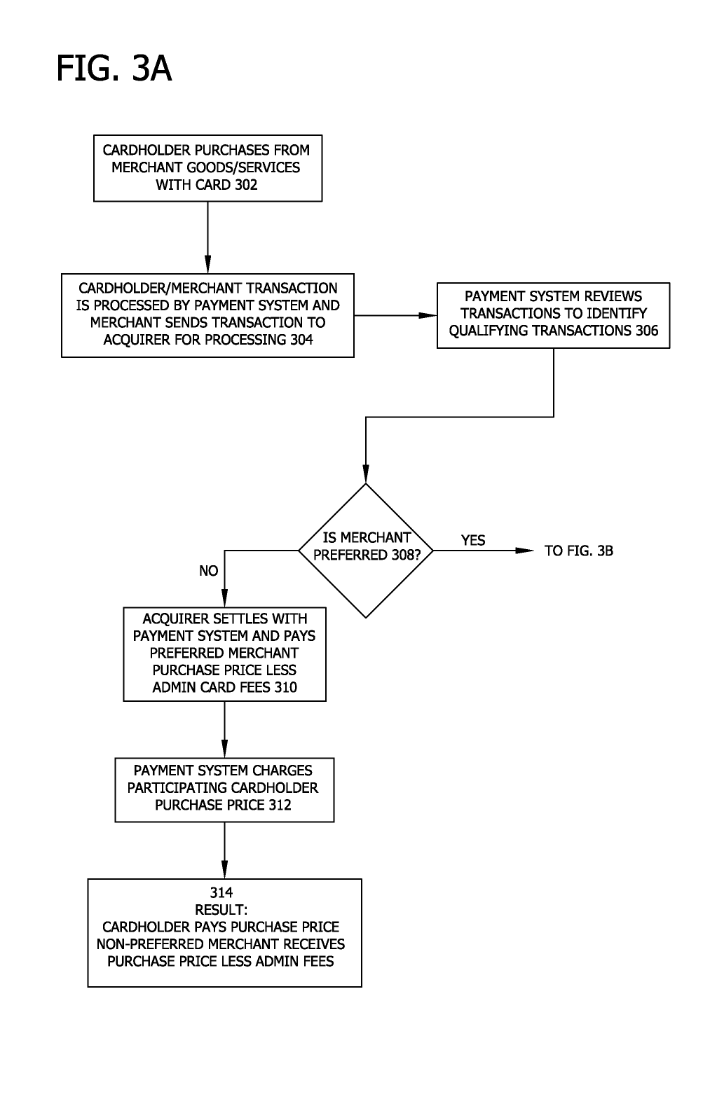

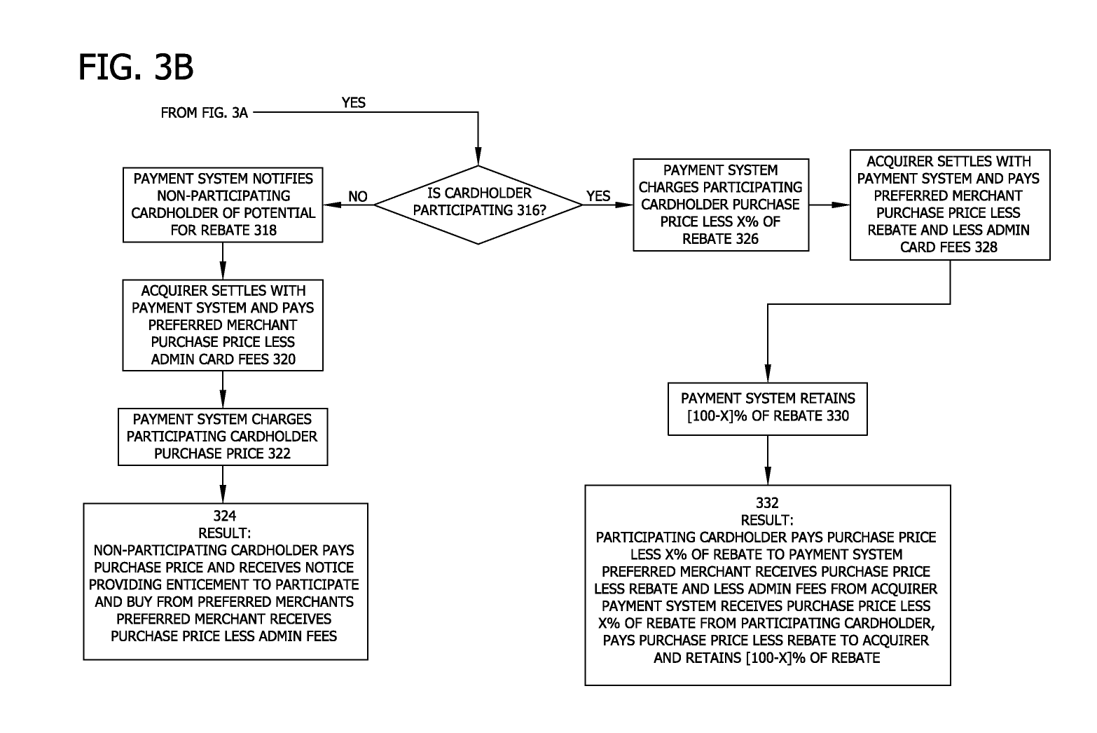

In operation, the database application 116, such as a processor of the card system 102 and/or another processor (not shown) executes computer-executable software instructions such as those illustrated in the exemplary flow charts of FIGS. 2 and 3.

Referring to FIGS. 2A AND 2B an exemplary flow chart illustrates one embodiment of the operation of the invention wherein the loyalty program is operated separately from the payment system. In this configuration, the preferred merchants 110 receive via the acquirer 128 the purchase price of the particular transaction less any administrative fees (e.g., 1-4%) that are usually charged as part of the card system 102. The payment system 102 (including payment system, bank payment system or other systems part of which or all which facilitate payment) also charges the participating cardholders 106 for the purchase price of their respective transactions. The loyalty program is separately implemented by collecting a rebate from the preferred merchants 110 and paying X % (e.g., 50-99%) of the rebate to the participating cardholders 106.

Referring in detail to FIGS. 2A AND 2B, a transaction begins at 202 with a cardholder purchasing from a merchant goods and/or services using a debit or credit card which is part of the payment system 102. At 204, the cardholder/merchant transaction is processed by the payment system 102 and the merchant sends a transaction to an acquirer 128 for processing. The acquirer 128 at 206 settles with the payment system 102 and pays the merchant the purchase price of the transaction less any customary administrative card fees. At 208, the payment system charges the participating card holder the purchase price according to the transaction.

Thereafter, the program database application 116 at 210 reviews transactions of the payment system 102 and identifies qualifying program transactions (defined as transactions which involve both a preferred merchant and a participating cardholder). In order to identify qualifying program transactions, the database application 116 must identify transactions which involve preferred merchants 110 and participating cardholders 106. The database application 116 refers to the participating cardholders and preferred merchants database 118 to identify participating cardholders and to identify preferred merchants and, as a result, is able to identify qualifying program transactions.

If it is determined at 212 that the merchant of a particular transaction is not a preferred merchant, the process proceeds to step 214 to essentially maintain the status quo. In this first scenario, the cardholder pays the purchase price, the non-preferred merchant receives the purchase price less any administrative fees and no further transactions with regard to rebates or rebates are implemented according to the loyalty program instructions 105. If it is determined at 212 that the merchant is a preferred merchant, and it is determined at 216 that the cardholder is not a participating cardholder, the processor proceeds to 218. In this second scenario, at 218, the payment system notifies non-participating cardholders of their potential for a rebate if they had been a part of the loyalty program. The result at 220 of this second scenario is that the non- participating cardholder 114 pays the purchase price of the transaction and receives a notice providing enticement to participate and buy from preferred merchants in the future and the preferred merchant receives the purchase price less any applicable administrative fees. In general, administrative fees are an optional aspect of the invention. Thus, this second scenario is transparent to the preferred merchant in that from the perspective of the preferred merchant there is no variation in the transaction with respect to rebates or rebates.

If it is determined at 212 that the merchant is a preferred merchant as listed in database 118 and if it is determined at 216 that the cardholder is a participating cardholder as listed in the database 118, the process proceeds to step 222 where the program database application 116 pays the payment system X % of the rebate (e.g., 1-99% of the rebate). Next, the process proceeds to step 224 at which point the program database application 116 collects a rebate from the preferred merchant. In general, the cardholder is usually paid before funds are collected because card settlement files are sent daily and processed daily. Although the merchant payment file is sent daily, the typical cutoff is noon so that the merchant fund collection usually occurs the next day.

Next, the payment system pays X % of the rebate to the participating cardholder 106 at 226. The program database application 116 retains the remainder (100−X) % of the rebate as a fee for administering the loyalty program at 228.

As a result of this third scenario, as indicated at 230, participating cardholders pay the purchase price of the transaction to the payment system and separately receive an X % rebate from the payment system, preferred merchants receive the purchase price less administrative fees from the acquirer and pay the rebate to the program database application 116 and the program manager receives the rebate from the preferred merchant, pays X % of the rebate to participating cardholders 106 via the payment system and retains (100−X) % of the rebate for administrative expenses.

Referring again to FIGS. 2A AND 2B, it can be noted that the first four steps 202-208 are steps in the initial processing of a cardholder transaction. Thus, steps 202-208 are implemented by the payment system 102 alone whereas the remaining steps are implemented by the database application 116 in combination with the payment system 102 and the acquirer 128. FIGS. 2A AND 2B are based on the issuer 104 and program manager 108 being separate and distinct entities so that payment system 102 would be independent of and separate and remote from the loyalty program 105 and database application 116. On the other hand, FIGS. 3A AND 3B are based on the issuer 104 and program manager 108 being integrated entities so the payment system 102 and loyalty program 105 are considered as one processor or system.

In particular with regard to FIGS. 3A AND 3B, the transaction begins with the cardholder purchasing from the merchant goods and/or services using the debit/credit card at 302. At 304, the cardholder/merchant transaction is processed by the payment system and the merchant sends the transaction to the acquirer for processing. Steps 302 and 304 correspond to steps 202 and 204 of FIGS. 2A AND 2B. Next, the payment system reviews transactions to identify qualifying program transactions at 306. This is in contrast to FIGS. 2A AND 2B wherein step 306 corresponds to step 210 and in FIGS. 2A AND 2B settlement with the acquirer and charging of the cardholder occur prior to the identification of qualifying program transactions.

At 308, the payment system determines whether the merchant is a preferred merchant by reference to the database 118. If the merchant is not a preferred merchant, the process proceeds to 310 where the acquirer settles with the payment system and pays the preferred merchant the purchase price less administrative card fees. The payment system charges the participating cardholder purchase price. As a result of this first scenario, the cardholder pays the purchase price and the non-preferred merchant receives the purchase price less administrative fees.

If it is determined at 308 that the merchant is a preferred merchant, the process proceeds to 316 to evaluate the cardholder with reference to database 118. If the cardholder is not a participating cardholder, the process proceeds to step 318 where the payment system notifies the non-participating cardholder of the potential for a rebate. In addition, the acquirer settles with the payment system at 320 and pays the preferred merchant the purchase price less administrative card fees. Also, the payment system charges the non-participating cardholder the full purchase price. As a result of this scenario the non-participating cardholder pays the purchase price and receives a notice providing an enticement to participate and buy from preferred merchants in the future and the preferred merchant receives the purchase price less administrative fees.

If it is determined at 316 with reference to database 118 that the cardholder is a cardholder participating in the loyalty program, the process proceeds to step 326 where the payment system charges the participating cardholder the purchase price less X % of the rebate. Next, the process proceeds to step 328 where the acquirer settles with the payment system and pays the preferred merchant the purchase price less the rebate and less the administrative card fees. It is contemplated that the acquirer would be aware of the rebate amount according in any of one or more convenient ways. For example, the acquirer may be provided access to the rebate/rebate database application 116 indirectly via the payment system 102 or directly via the preferred merchant website 124. Alternatively or in addition, the acquirer may be provided with files or other information in advance that would permit the acquirer to determine the rebate for a particular transaction. Alternatively or in addition, information appended to or within the transaction information may identify the rebate amount.

At 330, the payment system retains 100−X % of the rebate. As a result of this scenario as indicated at 332 the participating cardholder pays the purchase price less X % of the rebate to the payment system, the preferred merchant receives the purchase price less the rebate and less administrative fees from the acquirer. In addition, the payment system receives the purchase price less X % of the rebate from the participating cardholder, pays the purchase price less the rebate to the acquirer and retains 100−X % of the rebate.

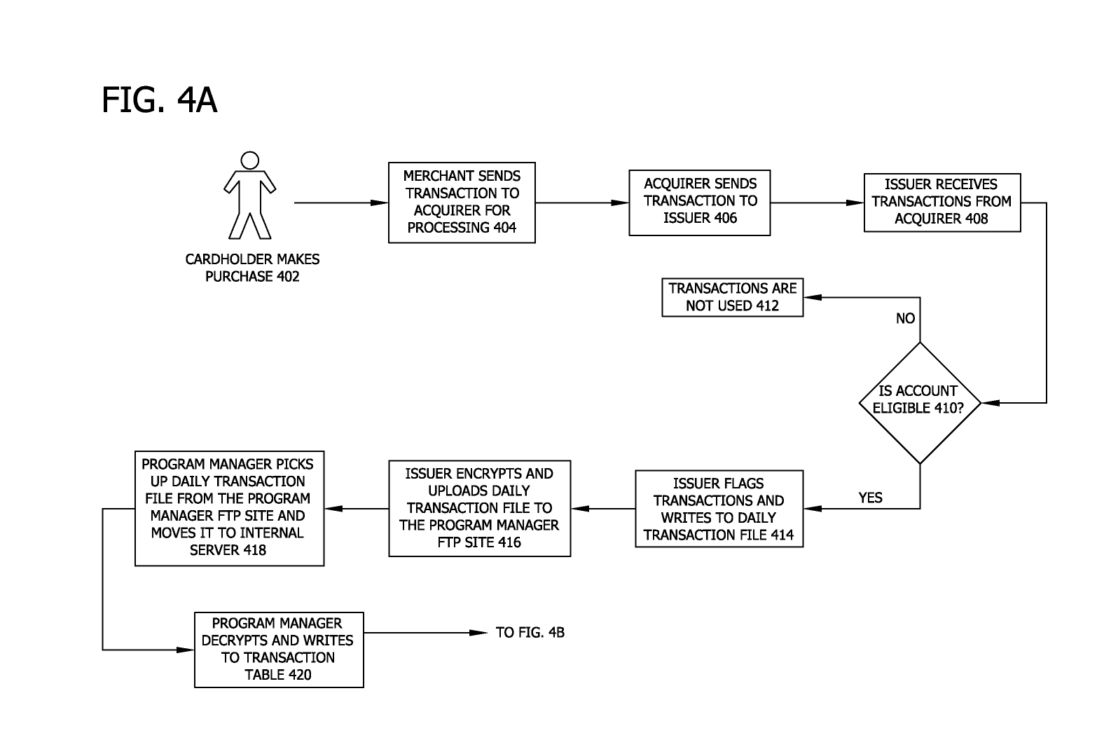

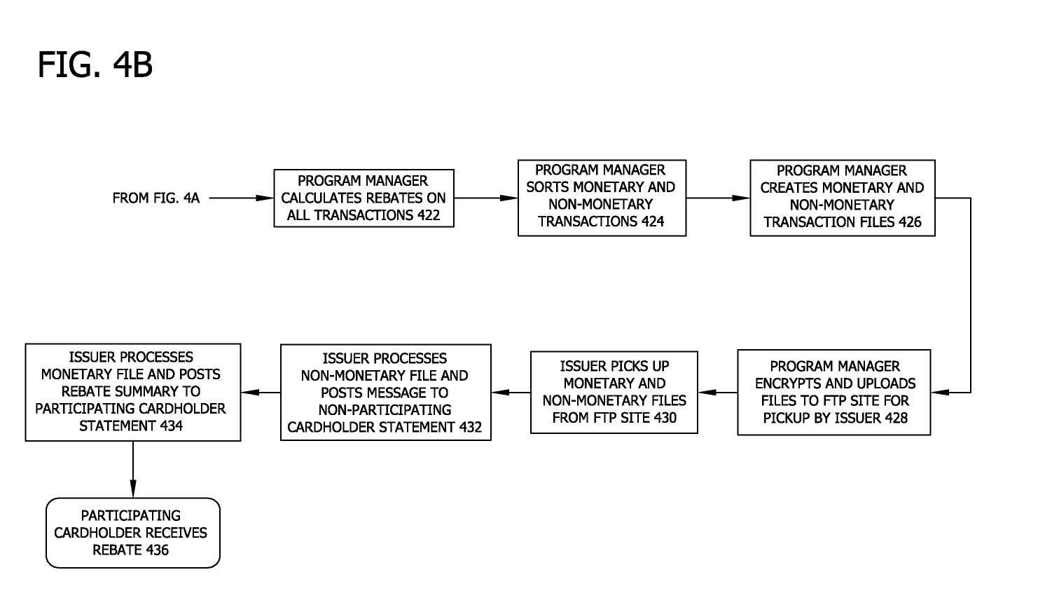

Referring to FIGS. 4A and 4B, a flow chart is illustrated in which 402-420 of FIG. 4A illustrate an exemplary embodiment of the daily incoming and outgoing transaction file process according to the invention corresponding to FIGS. 2A AND 2B. In addition, 422-436 of FIG. 4B illustrate an exemplary embodiment according to the invention of the process of notifying non-participating cardholders of the potential for rebates by posting non-monetary rebates to non-participating cardholders for the purpose of enticing the non-participating cardholders to enroll in the program and become participating cardholders. After a cardholder makes a purchase at 402, the merchant sends the transaction to the acquirer for processing at 404. At 406 the acquirer sends the transaction to the issuer and at 408 the issuer receives the transactions from the acquirer. At 410, the payment system 102 determines whether the particular transaction is eligible, e.g., the transaction involves a participating cardholder and/or a preferred merchant. If the transaction is not eligible, the transaction is not used as part of the rebate program and is completed at 412. On the other hand, if the transaction is eligible, the process proceeds to 414 where the issuer flags qualifying program transactions (e.g., transactions which qualify for rebates, such as transactions involving a participating cardholder and a preferred merchant) and writes a daily transaction file. At 416 the issuer encrypts and uploads the daily transaction file to the program manager FTP site. At 418 the program manager picks up daily transaction files from the program manager FTP site and moves the files to an internal server. At 420 the program manager decrypts and writes from the stored transaction files to transaction tables.

Referring to FIG. 4B, at 422 the program manager calculates rebates on all qualifying program transactions which involve preferred merchants and participating cardholders. At 424 the program manager sorts the monetary (preferred merchant and participating cardholder) and non-monetary (preferred merchant and non-participating cardholder) transactions and at 426 the program manager creates corresponding monetary and non-monetary transaction files. These files are encrypted and uploaded at 428 to the FTP site for pick up by the issuer 104. The issuer picks up the monetary and non-monetary files from the FTP site at 430 and processes the non-monetary files and posts corresponding messages to the non-participating cardholder statements at 432. In addition, the issuer processes the monetary files at 434 and posts rebate summaries to the participating cardholder statements so that at 436 the participating cardholder receives the rebate.

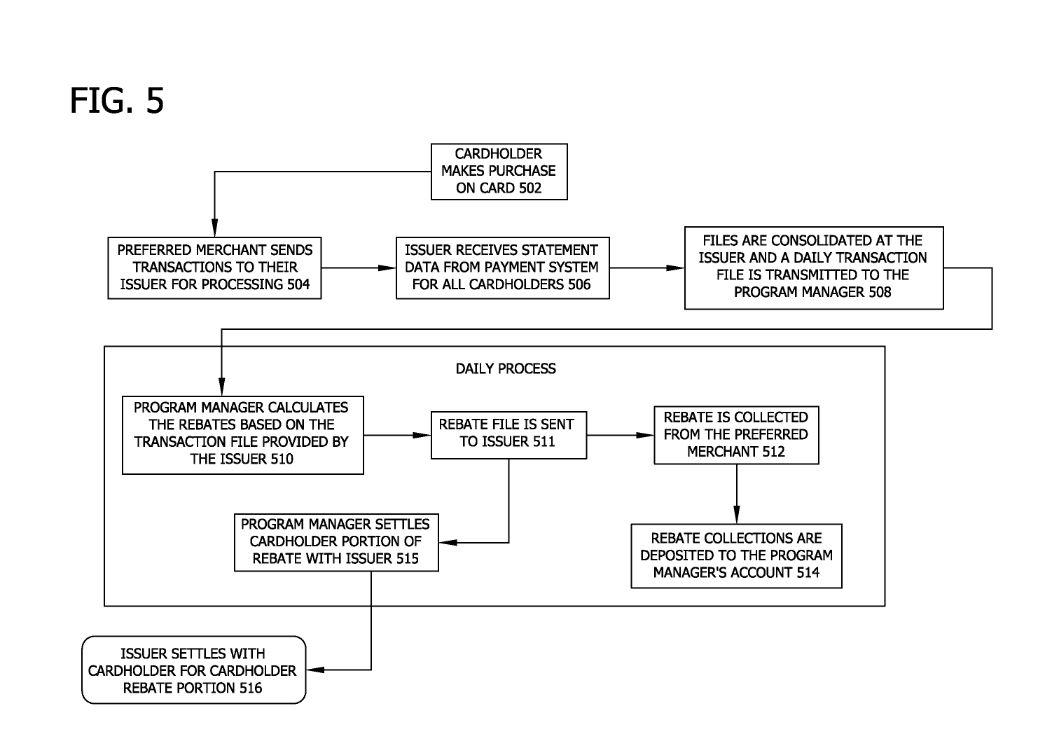

FIG. 5 is a flow chart illustrating an exemplary embodiment of the settlement process for a transaction involving a preferred merchant and a participating cardholder according to the invention. The process begins at 502 with a participating cardholder making a purchase on a card which is part of the card system 102. At 504, the preferred merchant sends the transactions to the issuer for processing. The issuer receives the statement data from the various payment systems of all cardholders at 506 and files are consolidated at the issuer at 508. A daily transaction file is transmitted to the program manager at 508. As a daily process, the program manager calculates the rebates based on the transaction file provided by the issuer at 510. At 511, the rebate file is sent to the issuer, who settles with the cardholder daily. 100% of the rebate is collected from the preferred merchant at 512 and the rebate collections are deposited to the program manager's account at 514. Also, the program manager settles the cardholder portion of the rebate with issuer at 515 and the issuer settles the cardholder for the portion of the rebate which is provided to the cardholder at 516.

In one embodiment, in 512, the payment is collected electronically from the preferred merchant through a pre-authorized debit. This is an improvement over prior programs that have relied on invoicing merchants.

FIG. 1 is a diagram illustrating the websites according to an embodiment of the invention. The interactive websites includes a participating cardholder website 122 in two languages. As described, the consumer website may include the following functionality: preferred merchant advertising, self-help tools (inquiry tools), enrollment and password verification, preferred merchant searching and personalization.

The websites also include a preferred merchant website 124 in two languages. This website may include the following functional aspects: Reporting, (transaction reporting, financial reporting, consumer activity reporting, program performance reporting), management of the merchant's web pages, management of users of merchant's web pages, and management of location, all as noted below.

The websites may optionally include a program manager website 120. The functionality of this website may include login and user management, activity management, partner management, financial management, consumer service support tools, program and activity reporting.

The following describes optional features of the system.

### Participating Cardholder Website 122

The purpose of this website 122 is to be a repository of merchant information for the cardholders From this website the cardholder will be able to enroll in the program, review and access merchant rebate and advertising information, customize their homepage and investigate rebate issues through the self help tools. All the information populated on this website is either fed from the merchant website 124 or through the program manager website 120. Note that this website 122 is also available to non participating cardholders and is a prime source of information as well as the means to entice non participating cardholders to enroll.

### Preferred Merchant Advertising

Website 122 may include rotating tile and banner ads which feature preferred merchants, allowing cardholders to click on a rotating advertisement to reach the preferred merchant page from the cardholder website 122. Cardholders can also enter the preferred merchant's own website through the preferred merchant page, and view special promotions and advertising from the preferred merchant. Each merchant sets up their web “page” on the merchant website which then feeds the consumer website. Once the merchant sets up their web page on the merchant web site, the cardholder can access the merchant's web page from the cardholder website. If the merchant has provided it, they can also access the merchant's regular website through this page, although they do not have to access the merchant website through the URL to enjoy the program—the merchant web page on the cardholder site provides enough information for cardholders to decide to shop at that merchant in most cases.

### Self Help Tools (Inquiry)

The participating cardholder website is responsive to the participating cardholder and is adapted to generate reports of transactions of the participating cardholders. Via website 122, cardholders can view all of their card transactions selected by date parameter, search to determine if the transaction is eligible for a rebate, search to determine if a merchant is preferred or not and what their rebate history has been over the life of the program. If there is a dispute over the rebate provided to a cardholder, the cardholder can submit a request electronically via website 122 to investigate this rebate. The investigation is electronically captured and sent to the issuer and/or program manager for further investigation. One purpose of these tools is to reduce calls to cardholder service.

### Enrollment And Password Verification

Cardholders enter their card number and expiry date to enroll via website 122. Cards are immediately verified through a web-to-web verification process, ensuring the cards are in good standing, and eligible to participate. The benefit to cardholders is that they can be instantly enrolled without a delay for approval. Cardholders select a password, and choose a question and answer in the event they forget their password. If they forget their password, the question and answer will immediately be verified, allowing them into the site and to select a new password. The password does not get emailed to them—the benefit being that cardholders who don't have email or who are not allowed to get email at work are able to use the site without waiting to receive an email, which they may or may not have access to.

### Preferred Merchant Searching

The participating cardholder website is responsive to the participating cardholder and is adapted to search information relating to the program. Cardholders can search by a number of criteria to find preferred merchants using website 122. Search parameters include city, merchant category, key word, and distance from their postal code. Postal codes are automatically populated, and cardholders can change their postal code in their preferences if they wish. Merchant pages show the location closest to the cardholder's postal code, as well as a list of other locations with maps.

### Personalization

The participating cardholder website is responsive to the participating cardholder and is adapted to personalize their view of the participating cardholder website. Cardholders can personalize their view of the website 122 by modifying their postal code, identifying which merchant categories they wish to show, identifying how many merchants they wish to see returned per page on a search, and adding a list of favorite merchants they always wish to see first.

### Preferred Merchant Website 124

Once a merchant has been activated by the program manager, the merchant will gain access to this website 124. This site will be the merchant's central information center whereby they can manage their web pages by uploading locations, logo's, images and descriptive copy for the program. This uploaded information is used to populate the cardholder website 122. This site 124 also provides the merchants with program reporting.

### Reporting

The preferred merchant website is responsive to the preferred merchant and is adapted to generate reports regarding the merchant's performance in the program as well as qualified transactions of the merchants. Merchants can use website 124 to see detailed reports on their card transactions at their locations, rolled up to a company level or by individual location. They can choose to see a full list of transactions including transactions by enrolled cardholders and those cardholders who are not enrolled, so they can compare the total volume and average spend between the cardholder groups. For each transaction they will see the purchase date, total value, and amount of the rebate payable, split between cardholder portion and program manager portion. They can also see comparisons of spend data by week or year over year by location or rolled up to a company level, to determine if the program is achieving results and meeting targets that have been set for new cardholder acquisition and increased overall spend within the target audience. This is an important, optional component of some embodiments of the program because it allows preferred merchants to accurately and easily measure how the program is performing for them. Another optional aspect of reporting available to merchants is Cardholder location (consumer Activity) reporting. Merchants can see where their cardholders are coming from by postal code FSA, which helps them in their marketing plans and to determine if they are stealing cardholders from their competitors (e.g. did a cardholder have to drive by a competitor to get to this location? Is one area of the city spending more than another?). Merchants can also reconcile the rebates paid on transactions with financial reporting, to ensure that all amounts paid are correct. See

### Manage Web Pages

The preferred merchant website 124 may responsive to the preferred merchant and adapted to permit the preferred merchant to set up, configure, modify and/or manage their own personal web page with full self service and generally requiring no intervention by the program manager. For example, preferred merchants may enter their own descriptive copy, logo, image, URL, phone number and other information that cardholders will see on the cardholder website, making it easy and efficient to build a “web page” for each preferred merchant. All information is approved through a web based approval system by the program manager before being published.

### Manage Users

The preferred merchant website is responsive to the preferred merchant and is adapted to permit the preferred merchant to control and/or manage users who access the preferred merchant website, including selectively granting one or more levels of security rights. A super user ID is assigned to an individual at the preferred merchant. He or she can then use website 124 to assign other user rights within their company or outside of it to allow others to view copy, reporting, information, or other aspects of the merchant website. This allows the preferred merchant to assign rights for example, to their accountant who might be an outside resource, who will help them reconcile rebate payments, or to assign rights to individual location managers who are only allowed to see their own store reports and not the entire company or other location reports.

### Manage Locations

Preferred merchants provide location information on their website by entering via website 124 individual locations, or by uploading an excel file with multiple locations. Location information drives the locations that the cardholder sees on the cardholder website, as well as the maps that cardholders will see. All locations are approved through a web based approval system before being published.

### Program Manager Website 120

The program manager(s) will have access to a web-based administration module via website 120. This module will be used by the program manager to manage all aspects of the program from the start of the merchant Sales Cycle Process right thru to managing cardholder/merchant investigations and fund settlement. This Information within this module feeds both the cardholder Website 122 and merchant Website 124.

### Program Management

The program manager may manage any or all aspects of the program from this website 120, including merchant sales activity, user access, website content, reporting, etc.

### Login and User Management

The program manager website 120 allows user security levels to be set and login ID's assigned to manage and monitor users (e.g., various administrators) of the website.

### Customer (Consumer) Service Support

The program manager uses this website 120 to investigate rebate disputes. All cardholder rebate disputes are shown in a case history file that records open investigations, resolution, length of time the investigation has been open (aging), and what type of transaction investigation it is. This information is passed back and forth from the issuer to the program manager to support cardholder service enquiries. An investigation can be entered through the cardholder service group or by the cardholder through the cardholder website 122. This system also includes an automated adjustment process for rebates once the issue has been resolved—the system automatically resubmits the rebate for processing, or reverses the rebate, as well as reviews a history for all other transactions that might have been affected by the issue that was found with this case.

### Preferred Merchant Strategy

This website 120 is used to drive the strategy for merchant solicitation and for determining which merchants should be solicited for the Program. From this website 120, program managers can access reports or look up individual merchants to learn about the spend of the merchant, number of locations and coverage (national, regional, or local), category of merchant, past history of any discussions, URL, the priority we have in soliciting this merchant, the probability in closing the sale, the contact names, and many other pertinent details.

### Financial Management

The program manager uses website 120 to manage rebate levels by partner, bank account information by partner, and to report on funds collected. This optional aspect allows the program manager to report on the funds collected from the merchants. The user can access files that have been generated by the system for the amounts of rebate to be collected from each merchant—all funds are collected through a Pre-authorized debit process electronically directly from the merchant's account. Banking information and/or issuer information for merchants is also set up in this section of the website 120. Reports from this section of the website indicate how much of the rebate collected is due to the cardholder vs. the program manager, and whether any funds are delinquent. If a debit is marked as delinquent, it can be automatically added to the next file transfer for the electronic debit process and the transaction is linked to the original debit attempt for audit and tracking purposes.

### Activity Management

The program manager can manage all sales activity (e.g., the solicitation of preferred merchants) through monitoring activity of those involved in soliciting merchants. Pre-formatted reports are available showing number of merchant contracts issued and signed, number of contacts made, and a variety of other reports. There is also an ad hoc reporting tool which can be used to run a report on any data that is held within the website database. This website 120 also contains a home page for each of the users in the program manager environment, where merchant reminders, action items, support requests, and appointments show up.

### Program And Activity Reporting

Reporting is available on all aspects of the data housed in the website 120 through an ad hoc reporting tool. The user can select what data they would like to see in the report, order it by column, filter it, and open the report in excel or HTML. The user can also save a query to be reused the next time.

### Preferred Merchant Management

This site 120 includes a full contact management system developed for this program. Merchant information is stored, contact points are logged, reminders can be set, support requests can be made of others in the organization, merchant Agreements can be uploaded to attach to the merchant in the database, etc.

### OTHER EMBODIMENTS OF THE INVENTION

In accordance with one aspect of the invention, a method provides handling card transactions of a card system including a plurality of participating cardholders, a plurality of non-participating cardholders, a plurality of non-preferred merchants and a plurality of preferred merchants, the card system for executing a loyalty program including the plurality of participating cardholders and the plurality of preferred merchants, the program being administered by an entity, the card system including a database of participating cardholders and preferred merchants; the method comprises:
evaluating transactions to identify qualifying program transactions involving a participating cardholders included in the database and a preferred merchant included in the database; and
implementing the loyalty program in response to identifying a qualifying program transaction in which one of the participating cardholders purchased goods or services from one of the preferred merchants for a purchase price.

In accordance with one aspect of the invention, a method provides handling card transactions of a card system including a plurality of participating cardholders, a plurality of non-participating cardholders, a plurality of non-preferred merchants and a plurality of preferred merchants, the card system for executing a loyalty program including the plurality of participating cardholders and the plurality of preferred merchants, the program being administered by an entity; the method comprises:
evaluating transactions to identify qualifying program transactions involving a participating cardholders and a preferred merchant;
implementing the loyalty program in response to identifying a qualifying program transaction in which one of the participating cardholders purchased goods or services from one of the preferred merchants for a purchase price; and
receiving from the preferred merchant of an identified, qualified transaction a rebate and wherein at least part of the rebate is provided to the participating cardholder and, optionally, part of the rebate is provided to the administering entity.

In accordance with one aspect of the invention, a method provides handling card transactions of a card system including a plurality of participating cardholders, a plurality of non-participating cardholders, a plurality of non-preferred merchants and a plurality of preferred merchants, the card system for executing a loyalty program including the plurality of participating cardholders and the plurality of preferred merchants, the program being administered by an entity; the method comprises:
evaluating transactions to identify qualifying program transactions involving a participating cardholders and a preferred merchant;
implementing the loyalty program in response to identifying a qualifying program transaction in which one of the participating cardholders purchased goods or services from one of the preferred merchants for a purchase price;
receiving from the preferred merchant of an identified, qualified transaction a rebate and wherein at least part of the rebate is provided to the participating cardholder and, optionally, part of the rebate is provided to the administering entity;
evaluating transactions to identify transactions involving a non-participating cardholders and a preferred merchant;
identifying a non-qualifying transaction in which one of the non-participating cardholders purchased goods or services from one of the preferred merchants for a purchase price; and
notifying the non-participating cardholder of an identified, non-qualified transaction that the non-qualified transaction would have resulted in a rebate to the non-participating cardholder if the non-participating cardholder was a participating cardholders.

In accordance with one aspect of the invention, a method provides for doing business employing a loyalty program in conjunction with a card system having qualified transactions and having non-qualified transactions wherein participating cardholders are part of the loyalty program and non-participating cardholders are not part of the loyalty program, the method comprises:
providing rebates to participating cardholders based on qualified transactions;
notifying non-participating cardholders of non-qualified transactions that the non-qualified transaction would have resulted in a rebate to the non-participating cardholder if the non-participating cardholder was part of the loyalty program.

In accordance with one aspect the invention is an internet-based loyalty program executed in conjunction with a card system including a plurality of participating cardholders, a plurality of non-participating cardholders, a plurality of non-preferred merchants and a plurality of preferred merchants, the card system including an integrated or separate processor for executing the loyalty program in which the loyalty program includes rebates for qualified transactions involving participating cardholders and preferred merchants. The program is administered by a program manager. The internet-based loyalty program includes instructions for implementing a preferred merchant website permitting preferred merchants to access their accounts showing qualified transactions.

In accordance with one aspect, the invention is an internet-based loyalty program executed in conjunction with a card system including a plurality of participating cardholders, a plurality of non-participating cardholders, a plurality of non-preferred merchants and a plurality of preferred merchants, the card system including an integrated or separate processor for executing the loyalty program in which the loyalty program includes rebates for qualified transactions involving participating cardholders and preferred merchants. The program is administered by a program manager. The internet-based loyalty program includes instructions for implementing a participating cardholder website permitting the participating cardholders to view preferred merchants and qualified transactions.

In accordance with one aspect, the invention is an internet-based loyalty program executed in conjunction with a card system including a plurality of participating cardholders, a plurality of non-participating cardholders, a plurality of non-preferred merchants and a plurality of preferred merchants, the card system including an integrated or separate processor for executing the loyalty program in which the loyalty program includes rebates for qualified transactions involving one of participating cardholders and one of the preferred merchants. The program is administered by a program manager. The internet-based loyalty program includes instructions for implementing a preferred merchant website permitting preferred merchants to provide a web page for the participating cardholders of the qualified transactions involving the preferred merchant; and a participating cardholder website permitting the participating cardholders to access their accounts showing qualified transactions and to access web pages of preferred merchants of the qualified transactions involving the participating cardholders

The program may further comprise a database identifying the plurality of participating cardholders and identifying the plurality of preferred merchants and wherein the processor evaluates transactions to identify transactions involving both a participating cardholder included in the database and a preferred merchant included in the database.

The loyalty program processor may execute instructions which result in the preferred merchant of an identified, qualified transaction paying an rebate; part of the rebate being provided to the participating cardholder of an identified, qualified transaction; and part of the rebate being provided to the administering entity.

The loyalty program processor may evaluate transactions to identify transactions involving a non-participating cardholders and a preferred merchant included in the database. The processor, in response to identifying a non-qualifying transaction in which one of the non-participating cardholders purchased goods or services from one of the preferred merchants for a purchase price, executes instructions which result in the non-participating cardholder of an identified, non-qualified transaction being provided a notification that the non-qualified transaction would have resulted in a rebate to the non-participating cardholder if the non-participating cardholder was a participating cardholders.

Merchant Funded Rewards Network with Rebate Embodiment

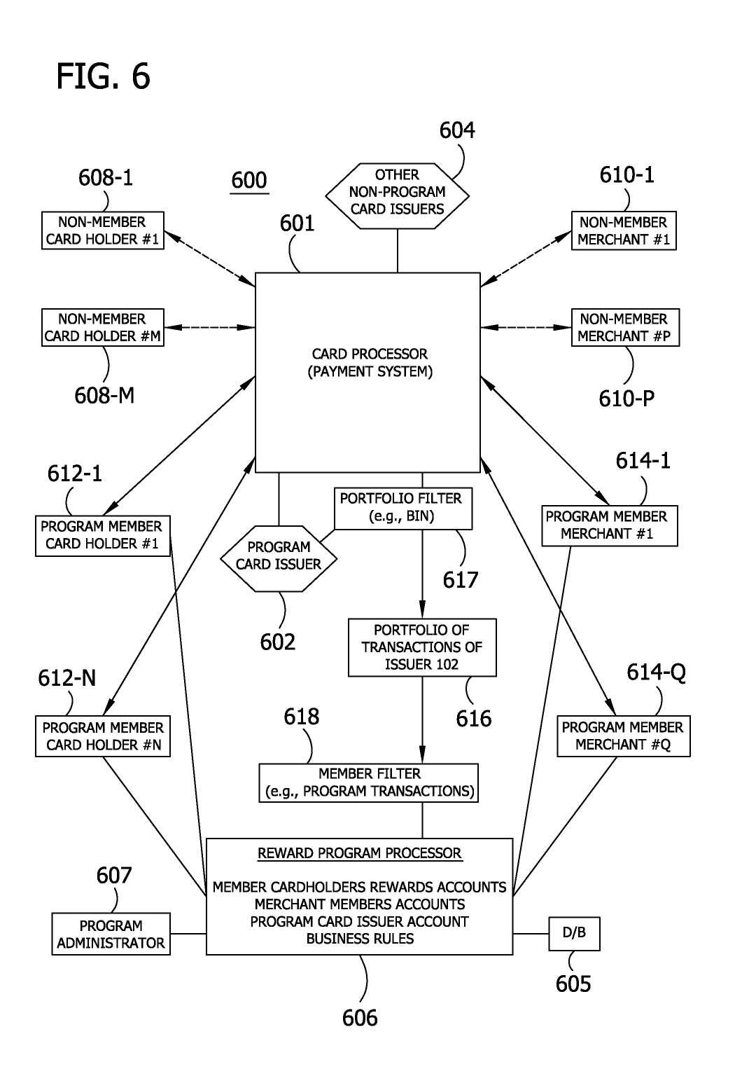

In one embodiment of the above system 100, the transaction data is provided to program manager 108 by the issuer 104 (see FIG. 1). The data is then filtered by program manager 108 to identify qualifying program transactions. In contrast, a merchant funded reward program 600 shown in FIG. 6 illustrates another embodiment of the invention. In the program 600, the transaction data is provided to a reward program processor 606 by a card processor (acquirer) 601 using a portfolio filter 617, such as filtering based on BIN (bank identification number). The data is then filtered by the reward program processor 606 operated by the program administrator 607 to identify qualifying program transactions. Thus, the handling of the data is different in program 600 than in the system 100 of FIG. 1.

Another difference is the handling of the merchant billing and the applying points to the member reward accounts. In the system 100, the rebate is charged to the merchant via a pre-authorized debit (DDA file) and points are applied to the reward accounts when the transaction data is received from the issuer. In contrast, in the program 600 the rebate is charged to the merchant periodically and points are applied to the reward accounts several days (e.g., 30 days) after the transaction data is received from the card processor.

The program 600 relates generally to the field of rewards programs which are funded by the merchant. In one embodiment, customers (e.g., card holders) of an issuer who are members of the program receive an additional reward for purchases from vendors (e.g., merchants) of an issuer who are members of the program. The reward can take many forms, but generally it is some type of account which can be used by the card holder to obtain awards (e.g., consumer electronics, airline tickets, gift cards). Rewards may be in the form of points, cash back, statement credits, frequent flier miles or other currency.

FIG. 6 is a block diagram illustrating the merchant funded reward program 600. As illustrated, a card processor 601 handles transactions of a card issuer 602 implementing a reward program processor 606 administered by a program administrator 607 separate and apart from the card issuer 602. The card processor 601 also handles transactions of other card issuers 604 which are not part of the reward program processor 606. The block diagram illustrates card holders and merchants involved in transactions using cards of the card issuer 602. Card holders and merchants of the other non-program card issuers 604 do not affect the reward program processor 606 and are not illustrated.

The card holders of issuer 602 include non-member card holders 608-1, 608-M and non-member merchants 610-1, 610-P. Transactions involving these non-member card holders or transactions involving non-member merchants do not affect the reward program processor 606. Thus, dashed lines are used to connect the non-members to the card processor 601.

The card holders of issuer 602 also include program member card holders 612-1, 612-N and program member merchants 614-1, 614-Q. Transactions between these member card holders and member merchants affect the reward program processor 606. A portfolio filter 617 identifies a portfolio of transactions (e.g., small business transactions) involving the card holders of issuer 602, which portfolio of transactions would include all transactions of member card holders 612 and non-member card holders 608, whether or not such transactions involve member merchants 614 or non-member merchants 610. The portfolio may include transactions involving member card holders 612 and non-member card holders 608. For example, issuer 602 would authorize processor 601 to provide all small business transactions to reward program processor 606.

The reward program processor 606 receives the portfolio of transactions of issuer 602 and applies a member filter 618 which may be based on a database 605 of program member cardholders 612 and program member merchants 614. The database 605 may be maintained by the program card issuer 602 or by the program administrator 607.

The member filter 618 identifies the transactions of the portfolio involving both program member card holders 612 and program member merchants 614 (i.e., program transactions). For example, the member filter 618 may be a two-stage filter which in a first stage filters the portfolio of transactions of issuer 602 to identify transactions involving member merchants 614. In as second stage, the member filter 618 filters the member merchant transactions from the first stage to identify transactions involving member card holders 612. The transactions from the second stage would be program transactions between member merchants 614 and member card holders 612. The business rules of the reward program processor 606 are applied to the program transactions to implement the reward program processor 606. It is contemplated that the portfolio filter 617 and the member filter 618 may be one integrated filter executed by the card processor 601 or by the reward program processor 606.

The program 600 uses the member filter 618 to provide a reward to member card holders 612 for transactions involving a merchant who is a program member. Initially, at least some transactions involving non-member card holders 608 may pass through the portfolio filter 617 (e.g., BIN filter) and be part of the portfolio of transactions. Thereafter, the portfolio of transactions involving a card holder who is a program non-member are filtered out by the member filter 618 because such transactions are not part of the rewards program and do not result in a reward added to the card holder's rewards account. Transactions involving a merchant who is a program non-member are filtered out by the merchant filter 618 because such transactions are not part of the rewards program and do not result in a reward added to the card holder's rewards account.

In one embodiment, at the point of sale, the consumer account number transmitted to the merchant is the account number, such as the card number. A separate account number which is independent of the card number is not used by the rebate program 600 and is not transmitted.

At the merchant, the card number and other transaction information are transmitted. In the rebate program 600, the amount paid by the merchant is specified by the business rules of the rewards program processor 606.

At the merchant, the card number and other transaction information are transmitted but the information transmitted does not specify a percentage rate to be paid by the merchant. In the rebate program 600, the percentage rate paid by the merchant is specified by the business rules of the rewards program 106.

In one embodiment, the invention comprises a system 600 for implementing a program. A card processor 601 (payment system) includes a plurality of participating account holders 612, a plurality of non-participating account holders 608, a plurality of non-preferred merchants 610 and a plurality of preferred merchants 614. The payment system processes transactions between the account holders 608, 612 and the merchants 610, 614 of the payment system. A portfolio filter 617 identifies a portfolio of processed transactions of a particular issuer 602. A program processor 606 executes a program including the plurality of participating account holders 612 and the plurality of preferred merchants 614 of the particular issuer 602. The program is administered by an entity such as a program administrator 607 separate from the issuer. A database 605 identifies the plurality of participating account holders 612 of the particular issuer 602 and the plurality of preferred merchants 614 of the particular issuer 602. The program processor 606 includes a member filter 618 for evaluating the portfolio of processed transactions 616 to identify transactions involving both a participating account holder 612 included in the database 605 and a preferred merchant 614 included in the database 605. The program processor 606 executes instructions implementing the program in response to identifying a qualifying program transaction in which one of the participating account holders 612 of the particular issuer 602 purchased goods or services from one of the preferred merchants 614 of the particular issuer 602 for a purchase price.

In one embodiment, the invention comprises a system 600 for implementing a program. A card processor 601 (payment system) includes a plurality of participating account holders 612, a plurality of non-participating account holders 608, a plurality of non-preferred merchants 610 and a plurality of preferred merchants 614. The payment system processes transactions between the account holders 608, 612 and the merchants 610, 614 of the payment system. A portfolio filter 617 identifies a portfolio of processed transactions of a particular issuer 602. A program processor 606 executes a program including the plurality of participating account holders 612 and the plurality of preferred merchants 614 of the particular issuer 602. The program is administered by an entity such as a program administrator 607 separate from the issuer. A database 605 identifies the plurality of participating account holders 612 of the particular issuer 602 and the plurality of preferred merchants 614 of the particular issuer 602. The program processor 606 includes a member filter 618 for evaluating the portfolio of processed transactions 616 to identify transactions involving both a participating account holder 612 included in the database 605 and a preferred merchant 614 included in the database 605. The program processor 606 executes instructions implementing the program in response to identifying a qualifying transaction in which one of the participating account holders 612 of the particular issuer 602 purchased goods or services from one of the preferred merchants 614 of the particular issuer 602 for a purchase price.

In one embodiment, the invention comprises a system 600 for implementing a program. A card processor 601 (payment system) includes a plurality of participating account holders 612, a plurality of non-participating account holders 608, a plurality of non-preferred merchants 610 and a plurality of preferred merchants 614. The payment system processes transactions between the account holders 608, 612 and the merchants 610, 614 of the payment system. A portfolio filter 617 identifies a portfolio of processed transactions of a particular issuer 602. A program processor 606 executes a program including the plurality of participating account holders 612 and the plurality of preferred merchants 614 of the particular issuer 602. The program is administered by an entity such as a program administrator 607 separate from the issuer. A database 605 identifies the plurality of participating account holders 612 of the particular issuer 602 and the plurality of preferred merchants 614 of the particular issuer 602. The program processor 606 includes a member filter 618 for evaluating the portfolio of processed transactions 616 to identify transactions involving both a participating account holder 612 included in the database 605 and a preferred merchant 614 included in the database 605. The program processor 606 executes instructions implementing the program in response to identifying a qualifying transaction in which one of the participating account holders 612 of the particular issuer 602 purchased goods or services from one of the preferred merchants 614 of the particular issuer 602 for a purchase price.

In one embodiment, the invention comprises a system 600 for implementing a program. A card processor 601 (payment system) includes a plurality of participating account holders 612, a plurality of non-participating account holders 608, a plurality of non-preferred merchants 610 and a plurality of preferred merchants 614. The payment system processes transactions between the account holders 608, 612 and the merchants 610, 614 of the payment system. A portfolio filter 617 identifies a portfolio of processed transactions of a particular issuer 602. A program processor 606 executes a program including the plurality of participating account holders 612 and the plurality of preferred merchants 614 of the particular issuer 602. The program is administered by an entity such as a program administrator 607 separate from the issuer. A database 605 identifies the plurality of participating account holders 612 of the particular issuer 602 and the plurality of preferred merchants 614 of the particular issuer 602. The program processor 606 includes a member filter 618 for evaluating the portfolio of processed transactions 616 to identify transactions involving both a participating account holder 612 included in the database 605 and a preferred merchant 614 included in the database 605. The program processor 606 executes instructions implementing the program in response to identifying a qualifying transaction in which one of the participating account holders 612 of the particular issuer 602 purchased goods or services from one of the preferred merchants 614 of the particular issuer 602 for a purchase price. The order of execution or performance of the methods illustrated and described herein is not essential, unless otherwise specified. That is, elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above systems and methods without departing from the scope of the invention, it is intended that all matter contained in the above description and shown in the accompanying drawings shall be interpreted as illustrative and not in a limiting sense.

What is claimed is:

1. A system for implementing a program comprising:
a card processor payment system including a plurality of participating account holders, a plurality of non-participating account holders, a plurality of non-preferred merchants and a plurality of preferred merchants, said payment system for processing transactions between the account holders and the merchants of the payment system;
a portfolio filter for identifying a portfolio of processed transactions of a particular issuer;
a program processor for executing a program including the plurality of participating account holders and the plurality of preferred merchants of the particular issuer, said program being administered by an entity separate from the issuer;
a database identifying the plurality of participating account holders of the particular issuer and the plurality of preferred merchants of the particular issuer;
said program processor including a member filter for evaluating the portfolio of processed transactions to identify program transactions involving both a participating account holders included in said database and a preferred merchant included in said database; and
said program processor executing instructions implementing the program in response to identifying a qualifying program transaction in which one of the participating account holders of the particular issuer purchased goods or services from one of the preferred merchants of the particular issuer for a purchase price.

2. The system of claim 1 wherein said program processor executes instructions which result in:
the preferred merchant of an identified, qualified program transaction being charged a rebate directly by the administering entity;
part of the rebate being provided to the participating account holder of an identified, qualified program transaction by the administering entity; and
optionally, part of the rebate being provided to the administering entity.

3. The system of claim 1 further comprising a member filter executed by the program processor for identifying program transactions involving both a participating account holder included in said database and a preferred merchant.

4. The system of claim 1 wherein the participating account holder is separately paid their part of the rebate after a first predefined period of time and wherein the participating merchant is separately charged their part of the rebate after a second predefined period of time.

5. The system of claim 1 wherein the preferred merchant is paid for the program transactions via an acquirer and wherein the preferred merchant is separately periodically charged rebates for the qualifying program transactions involving the preferred merchant during a previous period of time.

6. The system of claim 5 wherein the preferred merchant is paid by the acquirer for the program transaction purchase price and separately pays the rebate to the administering entity.

7. The system of claim 1 wherein the program processor obtains transactions of the particular issuer only directly from the card processor.

8. A system for implementing a program comprising:
a payment system including a plurality of participating account holders, a plurality of non-participating account holders, a plurality of non-preferred merchants and a plurality of preferred merchants;
a reward program processor for executing a program including the plurality of participating account holders of a particular issuer and including the plurality of preferred merchants of a particular issuer, said program being administered by an entity;
a filter evaluating transactions to identify program transactions involving both a participating account holders of the particular issuer and a preferred merchant of the particular issuer;
said reward program processor executing instructions implementing the program in response to identifying a qualifying program transaction in which one of the participating account holders purchased goods or services from one of the preferred merchants for a purchase price;
wherein said reward program processor executes instructions which result in: the preferred merchant of an identified, qualified program transaction paying a rebate; and
at least part of the rebate being provided to the participating account holder of an identified, qualified program transaction.

9. The system of claim 8 further comprising a database identifying the plurality of participating account holders of the particular issuer and identifying the plurality of preferred merchants of the particular issuer and wherein said reward program processor evaluates transactions to identify program transactions involving both a participating account holder included in said database and a preferred merchant included in said database.

10. The system of claim 9 wherein the participating account holder is separately paid their part of the rebate after a first predefined period of time and wherein the participating merchant is separately charged their part of the rebate after a second predefined period of time.

11. The system of claim 9 wherein the preferred merchant is paid for the program transaction via an acquirer and separately pays the rebate to the administering entity.

12. The system of claim 8 wherein the program obtains transactions of the particular issuer only directly from the payment system.

13. A system for implementing a program comprising:
a payment system including a plurality of participating account holders, a plurality of non-participating account holders, a plurality of non-preferred merchants and a plurality of preferred merchants;
a card processor for processing transactions between the account holders and the merchants;
a program processor for executing a program including the plurality of participating account holders of a particular card issuer and the plurality of preferred merchants of the particular card issuer, said program being administered by an entity separate from the issuer;
a database identifying the plurality of participating account holders of the particular card issuer and the plurality of preferred merchants of the particular card issuer;
a filter for identifying qualifying program transactions involving both a participating account holders included in said database and a preferred merchant included in said database; and
said program processor executing instructions implementing the program providing rebates to participating account holders in response to their identified qualifying program transactions.

14. The system of claim 13 wherein the filter comprises a portfolio filter identifying issuer transactions of a particular user and a member filter identifying qualifying program transactions from the issuer transactions.

15. A system for encouraging consumers to purchase goods or services via card-based payments, comprising:
a card issuer operative to issue cards to cardholders for use with merchants affiliated with the card issuer, said card issuer providing a loyalty program;
a payment system for handling a plurality of cardholders and merchants of various issuers, wherein at least a portion of the cardholders are participating cardholders of the card issuer that participate in the loyalty program and at least a portion of the merchants of the card issuer are preferred merchants that participate in the loyalty program, the loyalty program comprising a rebate for encouraging the participating cardholders of the card issuer to complete transactions with the preferred merchants of the card issuer via the payment system; and
a program administrator associated with the card issuer operative to administer the loyalty program by evaluating the transactions completed via the payment system to identify qualifying program transactions involving one of the participating cardholders and one of the preferred merchants and, for each qualifying program transaction, issuing at least a portion of the rebate to the participating cardholder, whereby the participating cardholder receives the at least a portion of the rebate based on actions taken by the program administrator.

16. The system of claim 15 wherein the card issuer is further operative to bill the participating card holder for the full amount of a purchase price associated with the transaction completed via the payment system and the program administrator bills the participating merchant for the rebate and issues at least a portion of the rebate to the participating cardholder.

17. The system of claim 16, wherein the program administrator obtains a payment for the rebate from the preferred merchant and, optionally, wherein the program administrator retains a portion of the payment for the rebate provided by the preferred merchant in the form of an administrative fee.
